(19) United States
(12) Patent Application Publication
(10) Pub. No.: US 2024/0412088 A1
(43) Pub. Date: Dec. 12, 2024

(54) TERNARY QUANTUM STATE READOUT USING BINARY-OUTCOME MID-CIRCUIT MEASUREMENTS

(71) Applicant: International Business Machines Corporation, Armonk, NY (US)

(72) Inventors: Naoki Kanazawa, Yokohama (JP); David C. Mckay, Ossining, NY (US); Haruki Emori, Sapporo (JP)

(21) Appl. No.: 18/330,452

(22) Filed: Jun. 7, 2023

(51) Int. Cl. G06N 10/20; G06N 10/40

(52) U.S. Cl. CPC G06N 10/20; G06N 10/40

(57) ABSTRACT

A device comprises memory that is configured to store program instructions, and processing circuitry, coupled to the memory, and configured to execute the program instructions to perform a process to measure a quantum state of a quantum bit. In performing the process, the processing circuitry is configured to: cause a sequence of operations to be performed on the quantum bit, the sequence of operations comprising at least a first binary-outcome measurement operation, a quantum state-inverting gate operation, and a second binary-outcome measurement operation; and determine a ternary measurement outcome, as the quantum state, based at least in part on discriminated binary-outcome measurements that result from the first binary-outcome measurement operation and the second binary-outcome measurement operation.

### BACKGROUND

This disclosure relates generally to quantum computing and, in particular, techniques for readout of ternary states of quantum information-storing units such as superconducting quantum bits (qubits). A quantum computing system can be implemented using a superconducting quantum processor which comprises an array of superconducting qubits, such as transmon qubits, to generate and process quantum information. Various types of quantum information processing operations (e.g., gate operations) can be performed in which superconducting qubits can be coherently controlled, placed into quantum superposition states (via, e.g., single-gate operations), exhibit quantum interference effects and become entangled with one another (via, e.g., entanglement gate operations).

Typically, quantum computing systems are configured to process quantum information that is encoded in a computational basis (|0 [symbol] or |1 [symbol] ) of the qubits, wherein gate operations are performed using the two lowest energy levels of a qubit including a ground state |0 [symbol] and a first excited state |1 [symbol] . A single qubit can have a basis state of |0 [symbol] or 1 [symbol] , or a linear combination of such basis states, which is known as a superposition state. In addition, quantum information can be encoded through entangled basis states of multiple qubits. On the other hand, some quantum systems are specifically configured to operate with quantum ternary digits (alternatively, quantum trits (qutrits)), wherein each qubit comprises a unit of quantum information having three states, including the ground state |0 [symbol] , the first excited state |1 [symbol] , and a second excited state |2 [symbol] , or a superposition of the three states |0 [symbol] , |1 [symbol] , |2 [symbol] .

While a two-level quantum system of qubits is typically designed and calibrated to operate in the computational subspace |0 [symbol] and |1 [symbol] there are instances where it may be desirable to measure the quantum state probability in a higher energy substrate (e.g., second excited state |2 [symbol] ) for purposes of characterizing system error (e.g., characterizing leakage to the second excited state |2 [symbol] resulting from gate operations in the computational subspace), or otherwise implementing a ternary quantum computation which fully utilizes the three states of |0 [symbol] , |1 [symbol] , |2 [symbol] . However, a standard measurement instruction provided by a quantum computing system only distinguishes probabilities in the computational subspace |0 [symbol] and |1 [symbol] , where readout control circuit of the quantum system is calibrated to readout and discriminate between |0 [symbol] and |1 [symbol] states. On the other hand, in order to process ternary measurement outcomes, e.g., measuring |0 [symbol] , |1 [symbol] , and |2 [symbol] state probabilities would require a modification of the existing microarchitecture and instruction set of a standard quantum computer that is configured to perform computations and measurements in the computational basis. The basic measurement instruction set for a quantum computer includes measurements only at the end of a circuit, however, more advanced sets include partial measurements (i.e., measurements of a subset of qubits) inside the quantum circuit, which are known as mid-circuit measurements.

### SUMMARY

Exemplary embodiments of the disclosure include techniques for measuring ternary quantum states of quantum information-storing units, such as quantum bits, using binary-outcome measurements. For example, an exemplary embodiment includes a device which comprises memory that is configured to store program instructions, and processing circuitry, coupled to the memory, and configured to execute the program instructions to perform a process to measure a quantum state of a quantum bit. In performing the process, the processing circuitry is configured to: cause a sequence of operations to be performed on the quantum bit, the sequence of operations comprising at least a first binary-outcome measurement operation, a quantum state-inverting gate operation, and a second binary-outcome measurement operation; and determine a ternary measurement outcome, as the quantum state, based at least in part on discriminated binary-outcome measurements that result from the first binary-outcome measurement operation and the second binary-outcome measurement operation.

Advantageously, the processing circuitry is configured to measure ternary outcomes (e.g., readout of |0 [symbol] , |1 [symbol] , and |2 [symbol] states) in a quantum system that is configured for binary-outcome measurement and readout of, e.g., a quantum bit in a computational basis of binary states (e.g., |0 [symbol] and |1 [symbol] states), while enabling measurements of a higher energy level (e.g., excited state |2 [symbol] of the quantum bit for purposes of computation and/or determining leakage, without modifying the existing microarchitecture and instruction set of the standard quantum computer which is utilized by the processing circuit to perform computations and measurements in the computational basis.

Another exemplary embodiment includes a system which comprises a quantum processing unit, and a computing system. The quantum processing unit comprise a quantum processor comprising an array of quantum bits, and a control system configured to control operation of the quantum processor. The computing system is configured to utilize the quantum processing unit to perform quantum computing algorithms. The computing system comprises memory that is configured to store program instructions, and processing circuitry, coupled to the memory, and configured to execute the program instructions to perform a process to measure a quantum state of a quantum bit of the quantum processor. In performing the process, the processing circuitry is configured to: generate control signals that are applied to the control system of the quantum processing unit to cause the control system to perform a sequence of operations on the quantum bit, the sequence of operations comprising at least a first binary-outcome measurement operation, a quantum state-inverting gate operation, and a second binary-outcome measurement operation; and determine a ternary measurement outcome, as the quantum state, based at least in part on discriminated binary-outcome measurements that result from the first binary-outcome measurement operation and the second binary-outcome measurement operation.

Another exemplary embodiment includes a computer program product for performing a process to measure a quantum state of a quantum bit. The computer program product comprises one or more computer readable storage media, and program instructions collectively stored on the one or more computer readable storage media. The program instructions comprise: program instructions to cause a sequence of operations to be performed on the quantum bit, the sequence of operations comprising at least a first binary-outcome measurement operation, a quantum state-inverting gate operation, and a second binary-outcome measurement operation; and program instructions to determine a ternary measurement outcome, as the quantum state, based at least in part on discriminated binary-outcome measurements that result from the first binary-outcome measurement operation and the second binary-outcome measurement operation.

In another exemplary embodiment, as may be combined with the preceding paragraphs, the quantum state-inverting gate operation comprises a quantum X gate operation that is configured to flip a state the quantum bit in a computational state spanned by a ground state |0 [symbol] and a first excited state |1 [symbol] , and the first binary-outcome measurement operation and the second [symbol] binary-outcome measurement operation are each performed using a mid-circuit measurement operation.

In another exemplary embodiment, as may be combined with the preceding paragraphs, the processing circuitry is configured to: receive a ternary measurement instruction; and translate the ternary measurement instruction into the sequence of operations to be performed on the quantum bit.

In another exemplary embodiment, as may be combined with the preceding paragraphs, the processing circuitry is configured to: cause the sequence of operations to be repeated for a specified number of times; for each sequence of operations that is performed, determine an associated single-shot ternary measurement outcome based on discriminated binary-outcome measurements that result from the sequence of operations; and determine the ternary measurement outcome based on a plurality of single-shot ternary measurement outcomes obtained as a result of the repeated sequence of operations.

In another exemplary embodiment, as may be combined with the preceding paragraphs, for each sequence of operations that is performed, the processing circuitry is configured to determine the associated single-shot ternary measurement outcome by performing a statistical analysis of the discriminated binary-outcome measurements to estimate the single-shot ternary measurement outcome.

In another exemplary embodiment, as may be combined with the preceding paragraphs, for each sequence of operations that is performed, the processing circuitry is configured to determine the associated single-shot ternary measurement outcome by utilizing a hardware-based sequential logic circuit to process the discriminated binary-outcome measurements.

Other embodiments will be described in the following detailed description of exemplary embodiments, which is to be read in conjunction with the accompanying figures.

### BRIEF DESCRIPTION OF THE DRAWINGS

FIG. 1 schematically illustrates a system that is configured to measure ternary quantum states using binary-outcome mid-circuit measurement operations, according to an exemplary embodiment of the disclosure.

FIG. 2 schematically illustrates a system that is configured to measure ternary quantum states using binary-outcome mid-circuit measurement operations, according to another exemplary embodiment of the disclosure.

FIG. 3 schematically illustrates a quantum processing system comprising control circuitry that is utilized to measure ternary quantum states using binary-outcome mid-circuit measurement operations, according to an exemplary embodiment of the disclosure.

FIG. 4 schematically illustrates a process of discriminating between ternary states based on voltage levels of readout signals, according to an exemplary embodiment of the disclosure.

FIG. 5 schematically illustrates a quantum computing system that is configured to measure ternary quantum states using binary-outcome mid-circuit measurements, according to an exemplary embodiment of the disclosure.

FIG. 6 schematically illustrates an exemplary architecture of a computing environment for hosting a quantum computing platform that is configured to measure ternary quantum states using binary-outcome mid-circuit measurements, according to an exemplary embodiment of the disclosure.

### DETAILED DESCRIPTION

Exemplary embodiments of the disclosure will now be described in further detail with regard to quantum computing systems which are configured to enable readout of ternary states of quantum information-storing units such as superconducting qubits or trapped-ion qubits. More specifically, exemplary embodiments as described herein include techniques for implementing ternary state readout (e.g., readout of |0 [symbol] , |1 [symbol] , and |2 [symbol] states) in a quantum system that is configured for qubit state readout of qubits in the computational basis (e.g., |0 [symbol] and |1 [symbol] states), while enabling measurements of the second excited state 12) for purposes of computation and/or determining leakage, without modifying the existing microarchitecture and instruction set of the standard quantum computer configured to perform computations and measurements in the computational basis.

It is to be understood that the various features shown in the accompanying drawings are schematic illustrations that are not drawn to scale. Moreover, the same or similar reference numbers are used throughout the drawings to denote the same or similar features, elements, or structures, and thus, a detailed explanation of the same or similar features, elements, or structures will not be repeated for each of the drawings. Further, the term “exemplary” as used herein means “serving as an example, instance, or illustration.” Any embodiment or design described herein as “exemplary” is not to be construed as preferred or advantageous over other embodiments or designs.

Further, it is to be understood that the phrase “configured to” as used in conjunction with a circuit, structure, element, component, or the like, performing one or more functions or otherwise providing some functionality, is intended to encompass embodiments wherein the circuit, structure, element, component, or the like, is implemented in hardware, software, and/or combinations thereof, and in implementations that comprise hardware, wherein the hardware may comprise quantum circuit elements (e.g., quantum bits, coupler circuitry, etc.), discrete circuit elements (e.g., transistors, inverters, etc.), programmable elements (e.g., application specific integrated circuit (ASIC) chips, field-programmable gate array (FPGA) chips, etc.), processing devices (e.g., central processing units (CPUs), graphics processing units (GPUs), etc.), one or more integrated circuits, and/or combinations thereof. Thus, by way of example only, when a circuit, structure, element, component, etc., is defined to be configured to provide a specific functionality, it is intended to cover, but not be limited to, embodiments where the circuit, structure, element, component, etc., is comprised of elements, processing devices, and/or integrated circuits that enable it to perform the specific functionality when in an operational state (e.g., connected or otherwise deployed in a system, powered on, receiving an input, and/or producing an output), as well as cover embodiments when the circuit, structure, element, component, etc., is in a non-operational state (e.g., not connected nor otherwise deployed in a system, not powered on, not receiving an input, and/or not producing an output) or in a partial operational state.

As is known in the art, quantum computing provides a computing paradigm which utilizes fundamental principles of quantum mechanics to perform computations. Quantum computing algorithms and applications are defined using quantum circuits. A quantum circuit is a computational routine which defines coherent quantum operations that are performed on quantum data that is stored in quantum bits, in conjunction with operations that are performed using classical computation. Quantum circuits are utilized to define complex algorithms and applications in an abstract manner, which can be executed on a quantum computer. In a quantum computer, primitive operations comprise gate operations (e.g., single-qubit gate operations, two-qubit gate operations, multi-qubit gate operations (e.g., 3 or more qubits) that are applied to qubits, to perform quantum computing operations for a given application. The quantum circuits allow a quantum computer to receive classical data, perform quantum operations based on the received data, and output a classical solution.

As noted above, a single qubit can have a basis state of |0 [symbol] or |1 [symbol] , or a linear combination of such basis states, which is known as a superposition state. As is known in the art, the state of a qubit can be graphically represented as a point on unit sphere (radius=1), which is called the Bloch sphere, with X, Y, and Z axes. The basis state |0 [symbol] (referred to as ground state) of a qubit is represented at a point (north pole) on a positive Z-axis of the Bloch sphere, while the basis state or |1 [symbol] (referred to as first excited state) of a qubit is represented at a point (south pole) on a negative Z-axis of the Bloch sphere. A superposition state |ψ [symbol] of the qubit can be represented as a point on the Bloch sphere as follows:

$$\vert ψ 〉 = cos \frac{θ}{2} \vert 0 〉 + {e}^{i ϕ} sin \frac{θ}{2} \vert 1 〉 ,$$

where the terms

$$cos \frac{θ}{2}$$

$$and$$

$$sin \frac{θ}{2}$$

correspond to the amplitude probabilities associated with the respective states |0 [symbol] and |1 [symbol] , and wherein the term e^{iϕ} corresponds to a relative phase between the states |0 [symbol] and |1 [symbol] . The position of a point on the Bloch sphere representing a superposition state of a qubit is determined based on the angles θ and ϕ. The angle θ influences the probability of observing a qubit state of |0 [symbol] or |1 [symbol] when the qubit is read, wherein the probability of reading a qubit state of |1 [symbol] increases as θ increases. The angle ϕ influences the relative phase between the states |0 [symbol] and |1 [symbol] . For example, when θ=0, the qubit is in the ground state |0 [symbol] , which provides a 100% probability of observing a qubit state of |0 [symbol] when the qubit state is read. In addition, when θ=π, the qubit is in the first excited state |1) [symbol] , which provides a 100% probability of observing a qubit state of |1 [symbol] when the qubit state is read. On the other hand, when

$$θ = \frac{π}{2}$$

and ϕ=0, the qubit is in a state at point on the positive X-axis of the Bloch sphere, and when

$$θ = \frac{π}{2}$$

$$and$$

$$ϕ = \frac{π}{2} ,$$

the qubit is in a state at a point on the positive Y-axis of the Bloch sphere.

The state of a given qubit can be changed by applying a single-qubit gate operation to the given qubit, which causes the current state of the qubit to rotate around, e.g., the X-axis, Y-axis, and/or Z-axis, etc., depending on the given gate operation. A rotation about the Z-axis results in a change in the angle ϕ. In addition, qubits can be controlled using entanglement gate operations to entangle the states of two or more qubits and, thereby, generate a combined state of two or more qubits, which contains more information than the individual states of the qubits. Entanglement allows multiple qubits in a superposition to be correlated with each other in a way that the state of one qubit can depend on the state of another qubit such that more information can be encoded with multiple entangled qubits as compared to encoding the qubits individually. Accordingly, quantum information processing, based on principles of superposition and entanglement states of qubits, allows quantum computers to solve difficult problems that are intractable using conventional computers.

Furthermore, as noted above, a qutrit is a quantum system which consists of three levels (states) spanned by e.g., the |0 [symbol] , |1 [symbol] , and |2 [symbol] states. The quantum state of a qutrit system may be represented by |ψ [symbol] =a₀|0 [symbol] +a₁|1 [symbol] +a₂|2 [symbol] , where the coefficients a₀, a₁, and a₂ are complex probability amplitudes, where the sum of squares of such coefficients is unity (normalization): |a₀|²+|a₁|²+|a₂|²=1. Ternary quantum computing systems using superconducting qutrits are considered to be promising alternatives to binary quantum computing systems for various reasons. A ternary quantum computing system, however, is specifically designed with a measurement instruction set and microarchitecture that is configured to execute qutrit measurement instructions and processes ternary measurement outcomes.

Furthermore, to implement high-fidelity single-shot qutrit readout operations, the qutrit readout signal (readout stimulus signal) and readout signal chain for the ternary quantum computing system is specifically engineered to readout and discriminate the |0 [symbol] , |1 [symbol] , and |2 [symbol] states with small assignment error. For example, a ternary state discrimination process can be implemented using a computationally expensive math library to determine nonlinear classification boundaries. In this instance, raw phasor signals (IQ data), which are obtained by performing multiple single shot qutrit readout operations, are transmitted from the control circuitry of quantum processing unit to a host processor of the ternary quantum computing system, where the processor executes a software-based ternary state discriminator process to discriminate the |0 [symbol] , |1 [symbol] , and |2 [symbol] states. Such software-based state discrimination is time consuming (as compared to hardware-based state discriminator) and consumes a significant amount of communication bandwidth to transmit the IQ data to the host processor.

On the other hand, as noted above, quantum computing systems are commonly configured to process quantum information that is encoded in a computational subspace that spans the |0 [symbol] and |1 [symbol] states, wherein the two lowest energy levels of qubits spanned by the |0 [symbol] and |1 [symbol] states are utilized for gate operations. In this regard, a binary quantum computing system is specifically designed with a measurement instruction set and microarchitecture that is configured to execute qubit measurement instructions and processes binary measurement outcomes. For example, a standard measurement instruction and microarchitecture of a binary quantum computing system is only configured to measure and distinguish qubit state probabilities in the computational basis states |0 [symbol] and |1 [symbol] .

Currently, in superconducting quantum computing systems, a transmon is a type of quantum information-storing unit that is commonly used to implement superconducting quantum processors. A transmon comprises a superconducting Josephson junction connected in parallel with a capacitor. The Josephson junction functions as a non-linear inductor which, when shunted with the capacitor, forms an anharmonic LC oscillator with individually addressable energy levels (e.g., two lowest energy level corresponding to the ground state |0 [symbol] and the first excited state |1 [symbol] ). While transmons are typically operated as two-level systems (qubits), transmons have readily addressable higher energy levels as a result of their anharmonicity characteristics, which allows the transmons to be operated as three-level systems (qutrits). In this regard, transmons can be utilized to implement a ternary quantum computing platform which can perform qutrit quantum computations in the computational subspace that spans the |0 [symbol] , |1 [symbol] , and |2 [symbol] states.

On the other hand, in a two-level quantum computing system where superconducting qubits (e.g., transmon qubits) are configured to operate in the computational subspace that that spans the |0 [symbol] and |1 [symbol] states, the ability to measure higher energy state probabilities is important to characterize errors of the two-level quantum system. For example, measuring quantum information in the |2 [symbol] state population is crucial to detect leakage errors that occur as a result of gate calibration operations and the execution of quantum algorithms. Indeed, gate operations that are performed on qubits in the computational subspace spanned by the |0 [symbol] and |1 [symbol] states can actually cause energy leakage to the |2 [symbol] state and, consequently, the measurement of |2 [symbol] state probabilities is important to characterize leakage errors. In this regard, to measure the |2 [symbol] state probability in a two-level quantum computing system that is specifically configured to distinguish state probabilities in the computational basis states of |0 [symbol] and |1 [symbol] , the two-level quantum computing system would typically need to be reconfigured to implement a custom measurement instruction and modified microarchitecture to execute ternary state readout operations and process ternary measurement outcomes, which is undesirable.

As noted above, exemplary embodiments of the disclosure include techniques to enable ternary state readout and measurement operations (e.g., readout and measurement of |0 [symbol] , |1 [symbol] and |2 [symbol] states) in a two-level quantum computing system without having to modify the existing microarchitecture and instruction set of the two-level quantum computer system. Such techniques generally include a process to determine a ternary state of a qubit by performing a ternary state readout process that generally includes performing a sequence of operations comprising (i) performing two or more binary-outcome measurements operations using mid-circuit measurement techniques, with an X-gate operation (alternatively referred to as “quantum NOT gate operation”) perform between two binary-outcome measurements to flip (invert) the state of the qubit between the ground |0 [symbol] and first excited |1 [symbol] states, or flip a superposition of the |0 [symbol] and |1 [symbol] states, and (ii) analyzing the two or more binary-outcome measurements to determine a ternary measurement outcome. As explained in further detail below, the exemplary ternary measurement protocols as discussed herein generated bit sequences that contain ternary state information in a format that is efficiently handled and processed using a standard micro-architecture of a commercial quantum computer.

It is to be noted that the term “binary-outcome measurement” as used herein denotes a measurement for an outcome M=E, 1−E, where E is some observable. For example, in some embodiments, a binary-outcome measurement instruction is configured to implement a positive operator-valued measure (POVM) of {|0 [symbol] 0|1−|0 [symbol] |}, wherein a state discriminator is calibrated to classify a given measurement outcome as a |0 [symbol] state or a NOT |0 [symbol] state, in which a given classification of NOT |0 [symbol] classifies a |1 [symbol] state and |2 [symbol] state into a same outcome classification (e.g., a |1 [symbol] state). In other embodiments, a binary-outcome measurement instruction is configured to implement a POVM of {|1 [symbol] 1|, 1−| [symbol] 1|}, wherein a state discriminator is calibrated to classify a given measurement outcome as a |1 [symbol] state or a NOT |1 [symbol] state, in which the NOT |1 [symbol] state classifies a |0 [symbol] state and |2 [symbol] state into a same outcome classification (e.g., a |0 [symbol] state).

In addition, the term “mid-circuit measurement” is a specification of a type of measurement which enables the quantum system to measure an outcome in the middle of a quantum circuit. In particular, a mid-circuit measurement is a unique feature that allows qubits to be selectively measured at some point other than the end of a quantum circuit. This is identical to the standard measurement from a viewpoint of measurement theory, but utilizes high-speed control electronics to process the readout measurement signals in real time.

In addition, in the context of the exemplary embodiments discussed herein, a “mid-circuit measurement” is performed using a quantum non-demolition (QND) measurement, which preserves the physical integrity of the system, wherein the a given state of a qubit can be measured (and thus preserved) without collapsing the state of the qubit as a result of the measurement. In a typical superconducting processor, a QND measurement is implemented using a dispersive readout scheme, where the quantum state of a give qubit is indirectly measured by generating and applying a readout control signal to stimulate a readout resonator that is coupled to the given qubit, and then analyzing a readout signal that is returned from the readout resonator to indirectly characterize the qubit state from the resonator transfer function. The readout signal that is returned from the stimulated readout resonator comprise a state-dependent phasor response (which is represented by a I and Q signal components of a complex phasor vector), in which the quantum state of the given qubit can be discriminated by analyzing the amplitude and phase of the readout signal. However, this amplitude and phase have broad distribution because of the noise in the amplifiers, and this sometime leads to the assignment error due to an overlap of signal distributions of different states.

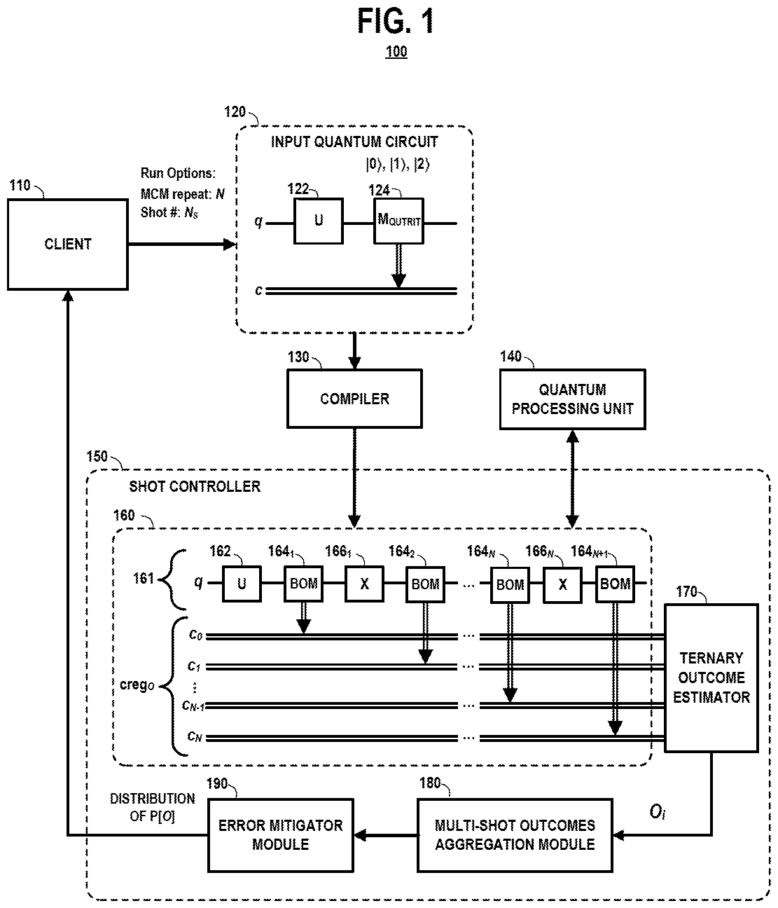

FIG. 1 schematically illustrates a system that is configured to measure ternary quantum states using binary-outcome mid-circuit measurement operations, according to an exemplary embodiment of the disclosure. In particular, FIG. 1 schematically illustrates a quantum computing system 100 which comprises a client 110 (e.g., user laptop computer, desktop computer, or other user computing device) that generates program instructions 120 (alternatively, input quantum circuit 120) to perform quantum information processing, a quantum compiler 130, a quantum processing unit (QPU) 140, and a shot controller 150. The shot controller 150 is configured to control the execution of a compiled quantum circuit 160 using the quantum processing unit 140. The shot controller 150 comprises a ternary outcome estimator module 170, a multi-shot outcomes aggregation module 180, and an optional error mitigation module 190, the function of which will be described in further detail below.

As schematically shown in FIG. 1, the program instructions 120 are depicted as an input quantum circuit which comprises a single qubit q, a single classical bit c, and an ordered sequence of operations that are performed on the qubit q including a U gate operation 122 and a measurement operation 124. The measurement operation 124 comprises a qutrit measurement instruction M_{QUTRIT}, and the qutrit measurement is mapped to the classical bit (c). The program instructions further specify run-time execution parameters including, but not limited to, a first parameter N which specifies a number of times to repeat a mid-circuit measurement (MCM) associated with the qutrit measurement instruction M_{QUTRIT}, and a second parameter N_{S} which specifies a number of single-shot ternary outcome measurements to perform in connection with the qutrit measurement operation, the details of which will be explained in further detail below.

The U gate operation 122 is a gate that performs a rotation around the Bloch sphere with three Euler angles, which are denoted θ, λ, and ϕ. The operation of the U gate can be described with the following matrix:

$$U = [ \begin{matrix}cos ( \frac{θ}{2} ) & - {e}^{i λ} sin ( \frac{θ}{2} ) \\ {e}^{i ϕ} sin ( \frac{θ}{2} ) & {e}^{i ( ϕ + λ )} cos ( \frac{θ}{2} )\end{matrix} ] .$$

The parameters of the U gate can be selected to replicate any other single qubit gate operation. For example, the U gate can be configured to replicate a Pauli-X gate by setting the parameters of the U matrix to be: θ=π, ϕ=π, and

$$λ = \frac{π}{2} .$$

As another example, the U gate can be configured to replicate a Hadamard gate by setting the parameters of the U matrix to be:

$$θ = \frac{π}{2} ,$$

ϕ=0, and λ=π. In this regard, the U gate operations shown in FIG. 1 are meant to generically represent any type of single gate operation performed on the qubit q, depending on the parameters of the U matrix.

The quantum compiler 130 comprises a quantum circuit compiler which is configured to translate the input quantum circuit 120 (or program instructions) into an optimized quantum circuit using, e.g., a native set of gates that are supported by a backend quantum computing service, e.g., computer simulator, or a quantum computing system comprising the quantum processing unit 140. In some embodiments, the quantum compiler 130 implements a transpilation process that is configured to rewrite a given input circuit to match the topology of a specific quantum device, and/or to optimize the circuit for execution by the quantum processing unit 140. For example, in the context of the exemplary embodiments discussed herein, the quantum compiler 130 is configured to decompose or otherwise translate the qutrit measurement instruction M_{QUTRIT} of the input quantum circuit 120 into a sequence of M_{mcm}(N)=[μ·X₀₁]^{N}·μ, wherein μ denotes a binary outcome measurement instruction with, a positive operator-valued measure (POVM) of {|0 [symbol] 0|, 1−| [symbol] 0|}, and wherein X₉₁ denotes an X gate instruction to flip (invert) the state of the qubit between the ground |0 [symbol] and first excited |1 [symbol] states, or flip a superposition of the |0 [symbol] and |1 [symbol] states. In other words, an X gate instruction performs a quantum state-inverting gate operation (or quantum X gate operation) that is configured to flip a state a quantum bit in a computational state spanned by a ground state |0 [symbol] and a first excited state |1 [symbol] .

More specifically, as illustrated in FIG. 1, the quantum compiler 130 translates the input quantum circuit 120 (program instructions) into the compiled quantum circuit 160 which is executed under control of the shot controller 150 to perform the qutrit measurement using binary-outcome mid-circuit measurement operations. The compiled quantum circuit 160 comprises a sequence of quantum operations 161 that are performed on the qubit q, and a classical bit register, denoted creg_{O}, to store measurement results. The sequence of quantum operations 161 comprises an initial U gate operation 162, binary-outcome measurement (BOM) operations 164₁, 164₂, . . . , 164_{N+1}, and X gate operations 166₁, . . . , 166_{N}. For ease of explanation, it is assumed that the U gate operation 162 of the compiled quantum circuit 160 is the same as the U gate operation 122 of the input quantum circuit 120. On the other hand, the measurement instruction 124 of the input quantum circuit 120 is compiled into the sequence of binary-outcome measurement operations 164₁, 164₂, . . . , 164_{N}, 164_{N+1}, and X gate operations 166₁, . . . , 166_{N}, as shown. The binary-outcome measurement operations 164₁, 164₂, . . . , 164_{N}, 164_{N+1} are mapped to respective classical bits c₀, c₁, . . . , c_{N-1}, c_{N} of the bit register creg_{O}.

In the exemplary embodiment of FIG. 1, the binary-outcome measurement operations 164₁, 164₂, . . . , 164_{N} comprise binary-outcome mid-circuit measurement operations which are followed by respective X gate operations 166₁, . . . , 166_{N}, while the binary-outcome measurement operation 164_{N+1} represents a final binary-outcome measurement for the given single-shot ternary measurement iteration. FIG. 1 schematically illustrates an exemplary embodiment in which the compiled quantum circuit 160 comprises N instances of the sequence [μ·X₀₁] of operations, i.e., [164₁·166₁], . . . [164_{N}·166_{N}], which is followed by the final binary-outcome measurement 164_{N+1}. In an exemplary embodiment where N=1 the sequence of operations for qutrit state readout would include the sequence: mid-circuit binary-outcome measurement operation 164₁→X gate operation 166₁→final mid-circuit binary-outcome measurement operation 164₂, and the classical bit register creg_{O} would include only classical bits c₀ and c₁ to store the results of the binary-outcome measurement operations 164₁ and 164₂, respectively.

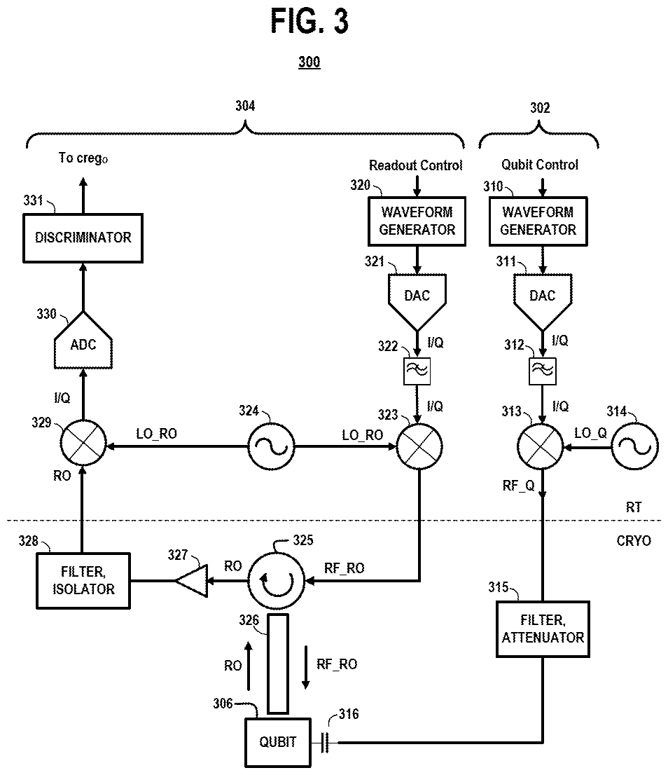

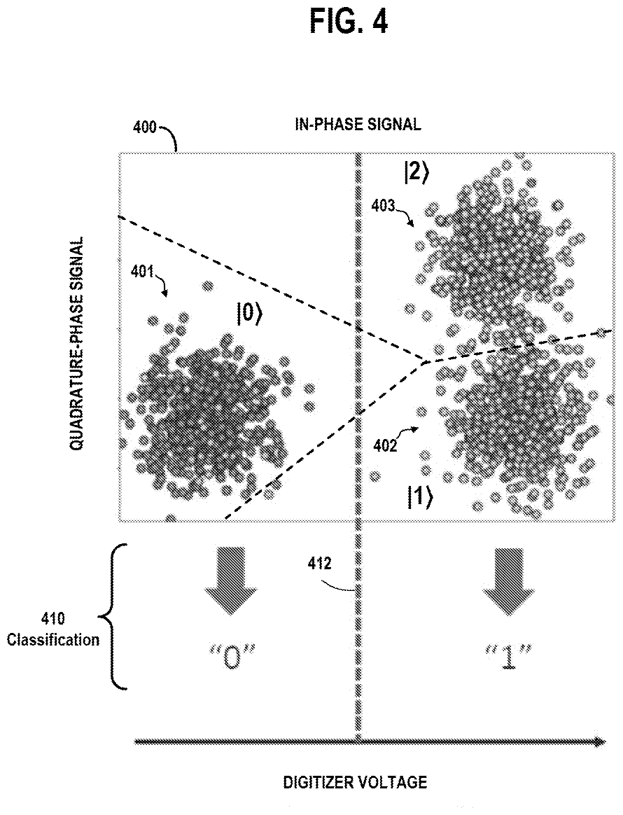

The shot controller 150 runs the compiled quantum circuit 160 by, e.g., generating and applying control signals to the quantum processing unit 140 to perform the U gate operation 162, the X gate operations 166₁, . . . , 166_{N}, and the binary-outcome measurement operations 164₁, 164₂, . . . , 164_{N}, 164_{N+1}, The quantum processing unit 140 is essentially a quantum computer which comprises one or more quantum chips which comprise an array of interconnected qubits and other quantum devices and components, e.g., qubit couplers, qubit control lines, qubit readout resonators, etc., and control circuitry (e.g., CMOS ASICS), which is coupled to the quantum chips via input signal chains and readout signal chains readout lines. The control circuitry is configured to generate qubit control signals and qubit readout control pulses in response to instructions from the shot controller 150 to perform qubit gate operations and qubit state readout operations, etc., the details of which will be explained in further detail below in conjunction with FIGS. 3 and 4.

As noted above, each binary-outcome measurement operation 1641, 164₂, . . . , 164_{N}, 164_{N+1} is performed using a quantum non-demolition measurement operation (via a dispersive readout of the qubit state) to measure the state of the qubit q and obtain a binary outcome measurement, wherein the state of the qubit q is measured as either |0 [symbol] or not |0 [symbol] (e.g., either |1 [symbol] or |2 [symbol] ). Each binary-outcome mid-circuit measurement results in the assignment of a label “0” for a measured ground state |0 [symbol] or a label “1” for a measurement that is “not” the ground state |0 [symbol] , e.g., the first excited state |1 [symbol] or the second excited state |2 [symbol] . In other words, measurement of the second excited state |2 [symbol] is assigned a label of “1”.

Further, each X gate operation 166₁, . . . , 166_{N} is performed using a standard X gate operation in the computational basis for the |0 [symbol] and |1 [symbol] states. The X gate operation is a quantum NOT gate operation that essentially mirrors the qubit around the X-axis of the Bloch sphere, wherein the qubit is rotated 180 degrees round the X axis. In this regard, the X gate operation swaps the ground state |0 [symbol] and the first excited state |1 [symbol] , while preserving the population of the second excited state |2 [symbol] . For example, with regard to the compiled quantum circuit 160 shown in FIG. 1, assume that following the U gate operation 162, the quantum state of the qubit q is in the second excited state |2 [symbol] . In this instance, the initial binary-outcome measurement operation 1641 will ideally result in a measurement of “1” due to the qubit q state being in the second excited state |2). In this state, applying the first X gate operation 1661 to the qubit q will not flip the state of the qubit q. As such, the next binary-outcome measurement operation 164₂ will ideally result in a measurement of “1” such that the initial 1, 1 measurement indicates that the quantum state of the qubit q (following the U gate operation 162) was in the second excited state |2 [symbol] .

On the other hand, assume that following the U gate operation 162, the quantum state of the qubit q is in the first excited state |1 [symbol] . In this instance, the initial binary-outcome measurement operation 1641 will ideally result in a measurement of “1” due to the qubit q state being in the first excited state |1 [symbol] . In this state, applying the first X gate operation 166₁ to the qubit q will flip the state of the qubit q from the first excited state |1 [symbol] to the ground state |0 [symbol] . As such, the next binary-outcome measurement operation 164₂ will ideally result in a measurement of “0” such that the initial 1, 0 measurements indicate that the quantum state of the qubit q (following the U gate operation 162) was in the first excited state |1 [symbol] .

Similarly, assume that following the U gate operation 162, the quantum state of the qubit q is in the ground state |0 [symbol] . In this instance, the initial binary-outcome measurement operation 164₁ will ideally result in a measurement of “0” due to the qubit q state being in the ground state |0 [symbol] . In this state, applying the first X gate operation 166₁ to the qubit q will flip the state of the qubit q from the ground state |0 [symbol] to the first excited state |1 [symbol] . As such, the next binary-outcome measurement operation 164₂ will ideally result in a measurement of “1” such that the initial 0,1 measurements indicate that the quantum state of the qubit q (following the U gate operation 162) was in the ground state |1 [symbol] .

The execution of a single iteration of the compiled quantum circuit 160 using quantum non-demolition measurements to obtain a sequence of mid-circuit measurement outcomes with a flip of the qubit state (via the X gate) between the ground and first excited states, results in the generation of a bitstream of discriminated binary outcomes B_{N}={0,1}^{N+1} which is represented by the logic states of the bits c₀, c₁, . . . , c_{N}, c_{N+1} in the classical bit register creg_{O}. For a given iteration of the ternary measurement, the bitstream of discriminated binary outcomes stored in the bit c₀, c₁, . . . , c_{N}, c_{N+1} are read into and processed by the ternary outcome estimator module 170.

The ternary outcome estimator module 170 is configured to estimate a single-shot ternary outcome O ∈{0,1,2}¹ based on the bitstream of discriminated binary outcomes B_{N}={0,1}^{N+1} that are generated from a single iteration of execution of the compiled quantum circuit 160. In some embodiments, the ternary outcome estimator module 170 is implemented using sequential logic circuitry that is implemented in, e.g., a hardware accelerator, an exemplary embodiment of which will be discussed below in conjunction with FIG. 3. In some embodiments, the ternary outcome estimator module 170 is implemented at least in part as a software module that implements a statistical analysis process to analyze the bitstream of discriminated binary outcomes to estimate a quantum state of the qubit q as being one of the |0 [symbol] , |1 [symbol] , and |2 [symbol] states.

For example, in some embodiments, the ternary outcome estimator module 170 implements any suitable statistical inference process, such as a maximum likelihood estimation (MLE) method, to estimate the quantum state of the qubit q based on the bitstream of discriminated binary outcomes. In general, MLE is a method of estimating the parameters of an assumed probability distribution, given some observed data, by maximizing a likelihood function so that, under the assumed statistical model, the observed data (i.e., bitstream of discriminated binary outcomes) is most probable. The MLE method selects the state estimate that gives the observed results with the highest probability.

The shot controller 150 performs multiple iterations of the execution of the compiled quantum circuit 160 based on the specified shot number N_{S}. In some embodiments, the shot number shot N_{S} is on the order of thousands (e.g., N_{S}=1000, or 2000, etc.). For each iteration i=1, . . . , N_{S}, the ternary outcome estimator module 170 determines the single-shot ternary outcome Oᵢ. The multi-shot outcomes aggregation module 180 is configured to receive and aggregate the single-shot ternary outcomes [O₁, O₂, O₃, . . . , O_{N}_{_{S}}] into a probability distribution representation (e.g., histogram) of the ternary outcome (denoted, distribution of P[O]), i.e., the probability distribution P[O] of the possible quantum states |0 [symbol] , |1 [symbol] , and |2 [symbol] of the qubit q as determined over the N_{S} single-shot iterations. For example, the probability distribution can be represented by the number of the single-shot ternary outcomes that estimated each of the possible quantum states |0 [symbol] , |1), and |2 [symbol] of the qubit q, e.g., {0: nₒ, 1: n₁, 2: n₂}, where nₒ denotes a number single-shot ternary outcomes that were estimated to be the ground state |0 [symbol] , where n₁ denotes a number single-shot ternary outcomes that were estimated to be the first excited state |1 [symbol] , and where n₂ denotes a number single-shot ternary outcomes that were estimated to be the second excited state |2 [symbol] .

In some embodiments, the distribution of P[O] generated by the multi-shot outcomes aggregation module 180 is returned to the client 110 as the result of the ternary measurement. On the other hand, in some embodiments, to provide more precise results, the error mitigation module 190 is utilized to perform readout error mitigation with a pre-calibrated assignment matrix using known techniques. For example, a three-state assignment matrix can be constructed and utilized to perform error mitigation using the probability distribution P[O] of the single-shot ternary outcomes [O₁, O₂, O₃, . . . , O_{N}_{_{S}}] of the measured ternary quantum state. In some embodiment, a readout error mitigation is performed by measuring an assignment matrix A with quantum detector tomography. The quantum state preparation and measurement errors can then be mitigated by applying the inverse of the assignment matrix to the measurement results, and then the most probable physical state is acquired using any suitable process. In particular, a mitigated probability p is derived by p′=A⁻¹·p_{noisy}, where an invalid probability p₀₀^{MXM} can be considered by the assignment matrix. The term p₀₀^{MXM} denotes a probability of measuring a “0” from both mid-circuit measurements in the sequence mid-circuit measurement→X gate→mid-circuit measurement (MXM) with N=1.

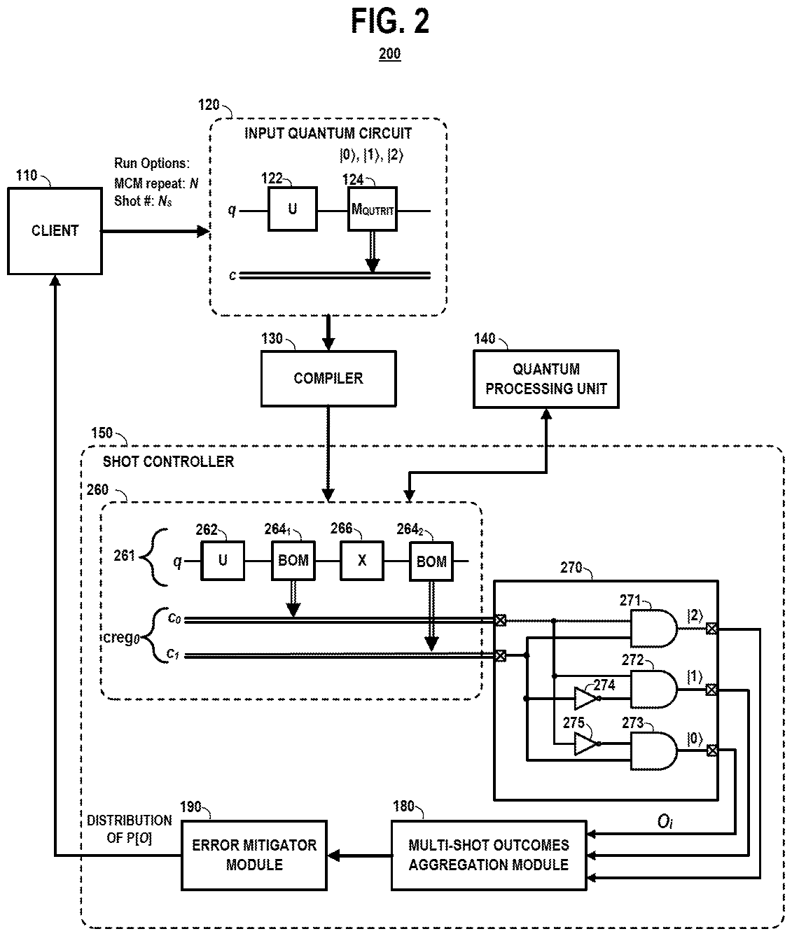

As noted above, in some embodiments, the ternary outcome estimator module 170 can be implemented in hardware using sequential logic circuitry. For example, in an exemplary embodiment in which the ternary measurement operation comprises N=1 instance of the sequence [μ·X₀₁] of measurement and state flip operations, and wherein the classical bit register creg_{O} comprises two bits, c₀ and c₁, a sequential logic circuit such as shown in FIG. 2 can be utilized to determine the single-shot ternary outcome Oᵢ for each ternary measurement iteration performed by the shot controller 150. For example, FIG. 2 schematically illustrates a system that is configured to measure quantum states of a ternary quantum system, according to another exemplary embodiment of the disclosure. In particular, FIG. 2 schematically illustrates a quantum computing system 200 which is similar to the quantum computing system 100 of FIG. 1, except that the FIG. 2 illustrates an exemplary embodiment where the qutrit measurement instruction M_{QUTRIT} of the input quantum circuit 120 is translated/decomposed into a sequence of M_{mcm}(N)=[μ·X₀₁]^{N}. μ, where N=1, and where the shot controller 140 implements a ternary outcome estimator logic circuit 270 (e.g., implemented by a hardware accelerator) that is configured to determine a single-shot ternary outcome Oᵢ for each ternary measurement iteration performed by the shot controller 150.

FIG. 2 schematically illustrates a compiled quantum circuit 260 which comprises a sequence of quantum operations 261 that are performed on the qubit q, and a classical bit register, denoted creg_{O}, to store measurement results. The sequence of quantum operations 261 comprises an initial U gate operation 262, binary-outcome measurement operations 264₁ and 264₂ and an X gate operation 266 (alternatively, quantum NOT gate operation 266), which perform the same functions/operations as discussed above. The binary-outcome measurement operation 264₁ is mapped to the classical bit c₀, and the binary-outcome measurement operation 264₂ is mapped to the classical bit c₁. For a given iteration of the ternary measurement performed by the shot controller 150, the bitstream of discriminated binary outcomes stored in the bit c₀ and c₁ are read out and input to the ternary outcome estimator logic circuit 270.

The ternary outcome estimator logic circuit 270 comprises a plurality of AND logic gates 271, 272, and 273, and a plurality of NOT logic gates 274 and 275 (or inverters). As schematically illustrated in FIG. 2, the AND gate 271 comprises a first input that receives the logic level of the first bit c₀, and a second input that receives the logic level of the second bit c₁. The AND gate 272 comprises a first input that receives the logic level of the first bit c₀, and a second input that is coupled to an output of the NOT gate 274 such that the second input of the AND gate 272 receives an inverted logic level of the second bit c₁. The AND gate 273 comprises a first input that is coupled to an output of the NOT gate 275 and receives an inverted logic level of the first bit c₀, and a second input which receives the logic level of the second bit c₁.

In this exemplary configuration, the AND gate 271 is configured to output a logic “1” level when the first and second bits c₀ and c₁ both have a logic “1” level, wherein the logic “1” level at the output of the AND gate 271 indicates a measured quantum state |2 [symbol] . The AND gate 272 is configured to output a logic “1” level when the first bit c₀ has a logic “1” level and the second bit c₁ has a logic “0” level, wherein the logic “1” level at the output of the AND gate 272 indicates a measured quantum state |1 [symbol] . Further, the AND gate 273 is configured to output a logic “1” level when the first bit c₀ has a logic “0” level and the second bit c₁ has a logic “1” level, wherein the logic “1” level at the output of the AND gate 273 indicates a measured quantum state |0 [symbol] . In the event that the first and second bits c₀ and c₁ both have a logic “0” level, the single-shot ternary outcome Oᵢ is classified as having an unknown state.

The hardware-based ternary outcome estimator logic circuit 270 is configured to provide accelerated computation of each single-shot ternary outcome Oᵢ and is particularly suited for instances where N=1, or possible some low number, e.g., N=2. In principle, N=1 is sufficient to determine the quantum state for each single-shot ternary measurement iteration. On the other hand, a mid-circuit binary-outcome measurement is not always accurate due to, e.g., quantum noise, or some error associated with the quantum state measurement operation. In this regard, increasing the number of instances of the [μ·X₀₁]^{N} where N>1 serves to mitigate or otherwise eliminate noise contribution associated with the mid-circuit binary-outcome measurements. As noted above, when N>1, statistical analysis methods are preferable used to enable a more precise estimate of the measurement outcomes.

It is to be appreciated that performing a single-shot ternary measurement using a minimal sequence of operations, such as shown in FIG. 2, comprising a first mid-circuit binary-outcome measurement operation 264₁, an X gate operation 266, and a second mid-circuit binary-outcome measurement operation 264₂ (referred to herein as an MXM sequence) serves to reduce the standard error or variance of the ternary measurement outcome, as compared to a measurement process based on combining two independent binary outcome measurement instances, i.e., a first circuit of [U-measure] and a second circuit of [U-X-measure]. The reduction in the standard deviation error or variance is based primarily on the fact that the first mid-circuit binary-outcome measurement operation 264₁ results in measured state that collapses to a measured |0 [symbol] state or a measured |1 [symbol] state (which may be the first excited state |1 [symbol] or the second excited state |2 [symbol] , and that the second mid-circuit binary-outcome measurement operation 264₂, which is performed after applying the quantum NOT gate operation 266 on the qubit, provides a deterministic outcome. This deterministic feature serves to reduce the standard deviation or variance of the measurement based on one MXM sequence. By increasing the number of shots of the MXM sequence, a further decrease in the standard error variance is achieved. For example, it is to be noted that computer simulations have shown that a standard deviation of about 0.01 can be achieved by performing 1000 single-shot ternary measurements using the MXM sequence, while the same standard deviation of about 0.01 would be achieved by performing about 4500 single-shot ternary measurements using a single ternary measurement operation.

FIG. 3 schematically illustrates a quantum processing system comprising control circuitry that is utilized to measure ternary quantum states using binary-outcome mid-circuit measurements, according to an exemplary embodiment of the disclosure. More specifically, FIG. 3 schematically illustrates a quantum processing system 300 comprising qubit control circuitry 302 and qubit readout control circuitry 304, which are configured to generate radio frequency (RF) control pulses to control the operation (gate operations, readout operation) of a superconducting qubit 306 (e.g., transmon qubit). The qubit control circuitry 302 and qubit readout control circuitry 304 implements a quadrature arbitrary waveform generator (AWG) system which is configured to generate control pulses using quadrature signals, wherein a quadrature signal comprises an in-phase (I) signal component, and a quadrature-phase (Q) signal component.

In some embodiments, the quantum processing system 300 schematically illustrates an exemplary architecture of the quantum processing unit 140 (FIGS. 1 and 2) at least with respect to a portion of the control circuitry that is utilized to control the operation of one fixed-frequency superconducting qubit (e.g., qubit q in FIGS. 1). In an exemplary implementation, the quantum processing unit 140 would have an array of qubits and qubit couplers to control/modulate exchange interaction between adjacent qubits to enable, e.g., entanglement operations, as well as additional control circuitry to control the operation (readout operations, gate operations) of the individual qubits, and control circuitry to generate flux bias control signal (e.g., static and dynamic flux bias control signal) to control operations of the qubit couplers, and tuning of flux-tunable qubits, etc., as is understood by one of ordinary skill in the art.

The qubit control circuitry 302 is configured to generate RF control pulses (denoted RF_Q) to control the operation, e.g., gate operations, state changes, etc., of the superconducting qubit 306. In an exemplary embodiment, the qubit control circuitry 302 would receive and process qubit control signals from the shot controller process 150 (FIGS. 1 and 2) to perform the U gate and X gate operations for a ternary state readout process. In particular, the qubit control circuitry 302 comprises a waveform generator 310 (or pulse envelope generator), digital-to-analog converter (DAC) circuitry 311, low-pass filter circuitry 312, an I/Q mixer 313 (upconverter mixer), a local oscillator (LO) signal generator 314, and an RF signal chain 315 that couples the RF output of the I/Q mixer 313 to the qubit 306. The RF signal chain 315 comprises one or more signal attenuators, a high pass filter, and transmission lines (e.g., coaxial cables, planar (printed) transmission lines, etc.). A capacitor 316 represents a qubit drive line that capacitively couples an RF control signal RF_Q from the RF signal chain 315 to the superconducting qubit 306.

The waveform generator 310 is configured to receive a qubit control signal and generate digital I and Q signals having a given type of pulse envelope (e.g., Gaussian pulse envelope) for qubit control, in response to the qubit control signal. The DAC circuitry 311 is configured to convert the digital I and Q pulses into analog I and Q control pulses which are filtered by the low-pass filter circuitry 312. The filtered analog control I and Q control pulses are applied to the I/Q mixer 313, along with an LO signal (LINQ) that is generated by the LO signal generator 314, to generate an RF control pulse RF_Q for qubit control. In particular, the I/Q mixer 313 is configured mix the analog I and Q control pulses with the LO_Q signals of a given LO frequency (e.g., 5 GHz) to perform I/Q modulation and upconversion using known techniques (e.g., single sideband modulation) to generate the RF qubit control signal RF_Q.

It is to be noted that the RF qubit control signal (RF_Q) for the superconducting qubit 306 comprises an RF control pulse which has a center frequency equal to a transition frequencies (denoted f₀₁) of the superconducting qubit 306, wherein the transition frequency f₀₁ corresponds to an energy difference between the ground state |0 [symbol] and excited state |1 [symbol] of the qubit. The RF_Q control signal comprises a shaped control pulse (e.g., Gaussian pulse) that is calibrated to drive f₀₁ transitions of the qubits, while suppressing f₁₂ and higher transitions. In addition, pulse-shaping techniques such as DRAG (derivative removal by adiabatic gate) correction pulses can be used in conjunction with shaped pulses (such as Gaussian pulses, cosine pulses, or hyperbolic secant pulses) to further suppress unwanted state transitions, while maintaining a same pulse envelope area (or integral of pulse envelope).

The RF qubit control signal RF_Q is applied to the superconducting qubit 306 to change the qubit state to perform single-qubit gate operations on the superconducting qubit 306 or otherwise modify the computational state of the superconducting qubit 306 as needed when performing certain operations, e.g., performing X gate operations to perform ternary measurements, as discussed above. The RF control signal RF_Q is configured to change the state of the superconducting qubit 306 by rotating the state of the qubit 306 about an axis in the Bloch sphere. Such rotations include X-axis rotations, Y-axis rotations, and/or rotations about any axis in the X-Y plane of the Bloch sphere, wherein the axis of rotation about a given axis of the Bloch sphere and the amount (angle) of such rotation are based, respectively, on the phase of the RF control signal RF_Q, and the amplitude and duration of the RF control signal RF_Q.

The qubit readout control circuitry 304 is configured to generate an RF readout control signal (RF_RO) to readout the state of the superconducting qubit 306 using a dispersive readout scheme which enables a quantum non-demolition measurement of the state of the superconducting qubit 306 to preserve the state of the superconducting qubit 306. In an exemplary embodiment, the qubit readout control circuitry 304 would receive and process readout control signals from the shot controller process 150 (FIGS. 1 and 2) to perform mid-circuit measurements for a ternary state readout process. The qubit readout control circuitry 304 comprises a waveform generator 320 (or pulse envelope generator), DAC circuitry 321, low-pass filter circuitry 322, a first I/Q mixer 323 (upconverter mixer), an LO signal generator 324, an RF circulator 325, a readout resonator 326, and a readout signal chain which comprises a quantum-limited amplifier 327, one or more filter and isolator components 328, a second I/Q mixer 329, analog-to-digital converter (ADC) circuitry 330, and a discriminator 331.

It is to be understood that FIG. 3 is an exemplary non-limiting embodiment which schematically illustrates a two transmission (TX) port architecture having one TX port for qubit control (e.g., XY control) and one TX port for qubit readout. In other embodiments, the qubit control circuitry 302 and qubit readout control circuitry 304 can be implemented with a single TX port in which, e.g., the outputs of the I/Q mixers 313 and 323 are applied to inputs of a signal combiner circuit, and an output of the signal combiner circuit is coupled to a single transmission path which transmits RF_Q and RF_RO signals to the superconducting qubit 306.

The waveform generator 320 is configured to receive and process and readout control signal to generate digital I and Q signals with a given type of pulse envelope (e.g., Gaussian square pulse envelope) for qubit state readout, in response to the readout control signal. The DAC circuitry 321 is configured to convert the digital I and Q pulses into analog I and Q control pulses which are filtered by the low-pass filter circuitry 322. The filtered analog control I and Q control pulses are applied to the I/Q mixer 323, along with an LO signal (LO_RO) that is generated by the LO signal generator 324, to generate an RF readout control pulse RF_RO. In particular, the I/Q mixer 323 is configured mix the analog I and Q control pulses with the LO_Q signals of a given LO frequency (e.g., 7 GHz) to perform I/Q modulation and upconversion using known techniques (e.g., single sideband modulation) to generate the RF readout control pulse RF_RO.

The RF readout control signal RF_RO is applied to an input port of the RF circulator 325, and then coupled to the readout resonator 326. The readout resonator 326 is capacitively coupled to the superconducting qubit 306, thereby providing a qubit/resonator system. In some embodiments, the readout resonator 326 comprises, e.g., a half-wavelength coplanar waveguide resonator, having a resonant frequency that is the same or similar to a center frequency of the RF readout control signal RF_RO. The resonant frequency of the readout resonator 326 is detuned from the transition frequency of the superconducting qubit 306. In the dispersive regime of qubit-resonator coupling (with non, the RF readout control signal RF_RO (with the requisite frequency tone, pulse envelope shape, and pulse duration) interacts with the given qubit/resonator system in manner which result in the generation of a resulting readout signal RO that is reflected out from the readout resonator 326, wherein the readout signal RO comprises information (e.g., phase and/or amplitude) that is qubit-state dependent. In other words, the dispersive readout process yields an RF readout signal RO having a state-dependent phasor response, which is analyzed to discriminate the quantum state of the superconducting qubit 306. Again, the dispersive readout process provides a quantum non-demolition measurement which does not perturb or otherwise collapse the quantum state of the superconducting qubit 306.

The readout signal RO that is returned from the readout resonator 326 is input to the RF circulator 325, and then coupled out to the readout signal chain where the readout signal RO is amplified by the quantum-limited amplifier 327, and then transmitted along a signal chain comprising the filter and isolator components 328, and applied to an input of the second I/Q mixer 329. The second I/Q mixer 329 mixes the RF readout signal RO with the LO_RO signal to perform a downconversion operation where the RF readout signal RO is downconverted and split into analog I and Q signals. The analog I and Q signals are input to the ADC circuitry 330 and sampled by the ADC circuitry 330 to generate respective digital I and Q signals that are indicative of the amplitude and phase of the readout signal RO. The discriminator 331 analyzes the digital I and Q signals to discriminate the measured quantum state of the superconducting qubit 306 based on the amplitude and phase components of the readout signal RO.

In some embodiments, the discriminator 331 comprises a hardware discriminator that is configured to discriminate binary-outcome measurements in the computational basis, e.g., discriminate between measured |1 [symbol] and |1 [symbol] states. In some embodiments, in the context of ternary state measurements, the discriminator 331 is calibrated to distinguish between a |0 [symbol] state and a NOT |0 [symbol] state (e.g., |1 [symbol] and |2 [symbol] states). For example, FIG. 4 schematically illustrates a process of discriminating between ternary states based on voltage levels of readout signals, according to an exemplary embodiment of the disclosure. In particular, FIG. 4 illustrates an exemplary two-dimensional (2D) scatter plot diagram 400 which shows different distributions 401, 402, and 403 of scatter points that represent single-shot readout signals in an IQ plane.

In the 2D scatter plot diagram 400, for each single-shot readout signal, the X-axis represents in I-phase component (amplitude), and the Y-axis represent the Q-phase component (phase) of the single-shot readout signal. The distribution of scatter points 401 represents a plurality single-shot readout signals in the IQ plane with a qubit prepared in a |0 [symbol] state. The distribution of scatter points 402 represents a plurality single-shot readout signals in the IQ plane with the qubit prepared in a |1 [symbol] state. The distribution of scatter points 403 represent a plurality single-shot readout signals in the IQ plane with the qubit prepared in a |2 [symbol] state. As shown, different distributions of scatter points are obtained depending on the quantum state of the qubit.

In addition, FIG. 4 schematically illustrates a classification process 410 for a binary outcome measurement, which is performed by the hardware discriminator 331 based on a calibrated discrimination plane 412 (e.g., threshold voltage). The discrimination plane 412 represent a threshold digitizer voltage level (on the X-axis) of the ADC circuitry 330 to distinguish between |0 [symbol] state and a NOT |0 [symbol] state (e.g., |1 [symbol] and |2 [symbol] states), wherein single-shot readout signal having an I-component with a voltage level less than the threshold voltage 412 is classified as a “0” (e.g., classical bit set to a logic “0” level), and wherein a single-shot readout signal having an I-component with a voltage level greater than the threshold voltage 412 is classified as a “1” (e.g., classical bit set to a logic “1” level). With this exemplary configuration, a measurement outcome of a |0 [symbol] state is classified as “0” and a measurement outcome of a |1 [symbol] state or a |2 [symbol] state is classified as “1”, thereby providing the basis of a binary-outcome measurement to measure a ternary state of a qubit.

It is to be noted that in practice, a given distribution of scatter points will have outliers which result from some finite measurement error. For example, assuming a qubit is in a |1 [symbol] or a |2 [symbol] state, while a majority of the single-shot readout signals will fall within the expected distribution of scatter points, there can be some outliers of single-shot readout signals that are classified to be in the |0 [symbol] state. Such outliers can be discarded from consideration using an error mitigation protocol as discussed above. Indeed, an error mitigation protocol utilizes prepared quantum states for the |0 [symbol] , |1 [symbol] and |2 [symbol] states within a three-state assignment matrix. After performing a ternary state readout process (as discussed above) and obtain distributions of actual measurement outcomes, the actual measured state can be compared against the prepared state, and an inverse of the assignment matrix is computed to collect the actual (correct) distribution of the measurement outcomes, with the knowledge of what outliers are expected to be obtained statistically.

It is be appreciated that FIG. 4 illustrates an exemplary embodiment in which a quantum computer can be calibrated to perform quantum operations in the computational basis comprising the basis states |0 [symbol] and |1 [symbol] , while reusing such calibration to perform ternary measurements using binary-outcome mid-circuit measurements as discussed above. In particular, the control circuitry of a quantum computer can be calibrated so that (i) the amplitude and/or phase of the single microwave tone of the readout control signal RF_RO is tuned to obtain good separation of scatter points between the ground state |0 [symbol] and the first excited state |1 [symbol] , and (ii) the hardware discriminator is optimally calibrated to discriminate between the ground state |0 [symbol] and the first excited state |1 [symbol] .

This is in contrast to a conventional embodiment for ternary state readout in which the control circuitry of the quantum computer would need to be calibrated by tuning the measurement stimulus (e.g., frequency, amplitude and/or phase of the readout control signal RF_RO) to obtain good separation of scatter points between the ground state |0 [symbol] , the first excited state |1 [symbol] , and the second excited state |2 [symbol] . In addition, a software-based discriminator process would be utilized to process the distribution of scatter points of measurement outcomes obtained for a given ternary state readout operation to precisely determine the state of the ternary system. This would require the quantum computing system to return the measured single-shot IQ data points to a host processor to calibrate a ternary state discriminator by using a computationally expensive mathematical software (e.g., sklearn in Python), and then for each set of measurement outcomes for a given ternary measurement, return the associated IQ data points to the host system for processing by the software-based discriminator process to determine the measured state (e.g., |0 [symbol] , |1) [symbol] or |2 [symbol] ). This process consumes a relatively large amount of communication bandwidth for the downstream traffic of a large complex array representing IQ data points, which limits scaling. Overall, the need to calibrate an additional and separate measurement operation for a ternary readout, in addition to a binary readout, would add cost to the quantum computing system.

Advantageously, the exemplary binary-outcome mid-circuit measurement techniques as discussed herein allow the quantum computing system to be calibrated for binary outcome measurements, while being reusable for ternary outcome measurements. The exemplary ternary state readout techniques as discussed herein rely on standard binary qubit readout operations, which are computationally inexpensive and may be implemented using an embedded system with a hardware-based discriminator, which does not require the raw IQ data to be returned to a host processor for processing by a software-based discriminator of the quantum operating system for ternary state discrimination. Instead, the exemplary ternary state readout techniques as discussed herein enable, e.g., a measurement of the probability of the second excited state |2 [symbol] to evaluate the leakage from the computational basis after a given operation by utilizing a ternary state readout instruction to measure the second excited state using a standard quantum computer that is calibrated for the computational basis without having to modify (or integrate another measurement scheme for the readout system) or upgrade the microarchitecture of the quantum computing system.

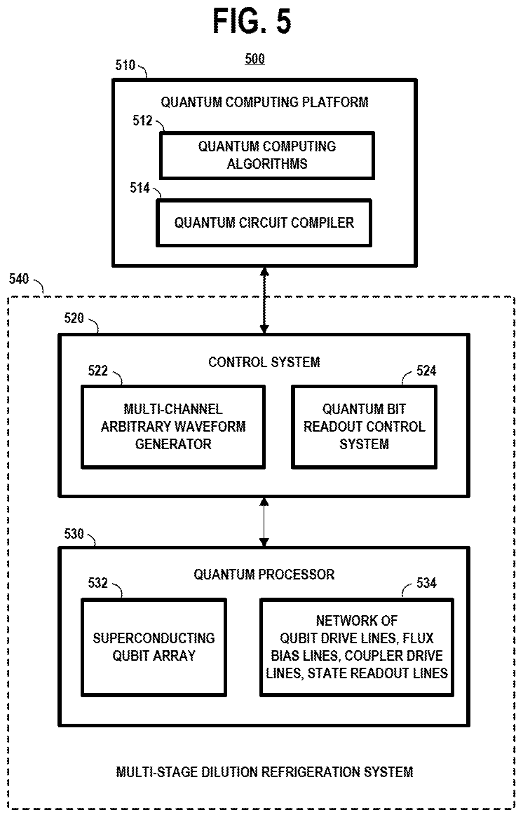

FIG. 5 schematically illustrates a quantum computing system that is configured to measure ternary quantum states using binary-outcome mid-circuit measurements, according to an exemplary embodiment of the disclosure. In particular, FIG. 5 schematically illustrates a quantum computing system 500 which comprises a quantum computing platform 510 (more generally, computing system), a control system 520, and a quantum processor 530. In some embodiments, the quantum computing platform 510 implements a software platform that is configured to program a quantum computer to execute quantum computing algorithms 512 which are implemented using, e.g., quantum circuits which define computational routings consisting of coherent quantum operations on quantum data, such as qubits. The quantum computing platform 510 comprises a quantum compiler 514 which adapts quantum circuits to conform to a specific device topology of a given quantum computer system and/or optimizing for execution on a noisy quantum computing system. As noted above, the quantum compiler 514 is configured to decode a ternary measurement instruction into a sequence of binary-outcome mid-circuit measurements to enable ternary state readout in a quantum processing system having a standard micro-architecture that is configured for the computational basis states of |0 [symbol] and |1 [symbol] , and which supports a dispersive readout architecture.

In addition, in some embodiments, the control system 520 comprises a multi-channel arbitrary waveform generator 522, and a quantum bit readout control system 524. The quantum processor 530 comprises at least one quantum chip having a superconducting qubit array 532 and a network 534 of qubit drive lines, coupler flux-bias control lines, and qubit state readout lines, and other circuit QED components that may be needed for a given application or quantum system configuration. In some embodiments, the superconducting qubit array 532 comprises a quantum system comprising an array of superconducting data qubits, superconducting auxiliary qubits, and superconducting flux-tunable couplers, arranged in a heavy hexagonal lattice topology or square lattice topology.

In some embodiments, the control system 520 and the quantum processor 530 are disposed in a dilution refrigeration system 540 which can generate cryogenic temperatures that are sufficient to operate components of the control system 520 for quantum computing applications. For example, the quantum processor 530 may need to be cooled down to near-absolute zero, e.g., 10-15 millikelvin (mK), to allow the superconducting qubits to exhibit quantum behaviors. In some embodiments, the dilution refrigeration system 540 comprises a multi-stage dilution refrigerator where the components of the control system 520 can be maintained at different cryogenic temperatures, as needed. For example, while the quantum processor 530 may need to be cooled down to, e.g., 20 mK or below (e.g., 10-15 mK) the circuit components of the control system 520 may be operated at cryogenic temperatures greater than 10-15 mK (e.g., cryogenic temperatures in a range of 3K-4K), depending on the configuration of the quantum computing system. In other embodiments, some or all of components of the multi-channel arbitrary waveform generator 522 and/or quantum bit readout control system 524 can be implemented in a room temperature environment, while the signal chains (for control signal input, and read signal output) extend from a room temperature environment through different temperature stages (e.g., five temperature stages: 20 millikelvin (mK), 100 mK, 1K, 3-4K, 40K) of the dilution refrigeration system 540.

The network 534 of qubit drive lines, coupler flux bias control lines, and qubit state readout lines, etc., is coupled to the control system 520 through a suitable hardware input/output (I/O) interface, which couples I/O signals between the control system 520 and the quantum processor 530. For example, the hardware I/O interface may comprise various types of hardware and components, such as RF cables, wiring, RF elements, optical fibers, heat exchanges, filters, amplifiers, isolators, etc.

The quantum computing platform 510 comprises a software and hardware platform which comprises various software layers that are configured to perform various functions, including, but not limited to, generating and implementing various quantum applications using suitable quantum programming languages, configuring and implementing various quantum gate operations, compiling quantum programs into a quantum assembly language, implementing and utilizing a suitable quantum instruction set architecture (ISA), performing calibration operations to calibrate the quantum circuit elements and gate operations, etc. In addition, the quantum computing platform 510 comprises a hardware architecture of processors, memory, etc., which is configured to control the execution of quantum applications, and interface with the control system 520 to (i) generate digital control signals that are converted to analog microwave control signals by the control system 520, to control operations of the quantum processor 530 when executing a given quantum application, and (ii) to obtain and process digital signals received from the control system 520, which represent the processing results generated by the quantum processor 530 when executing various gate operations for a given quantum application.

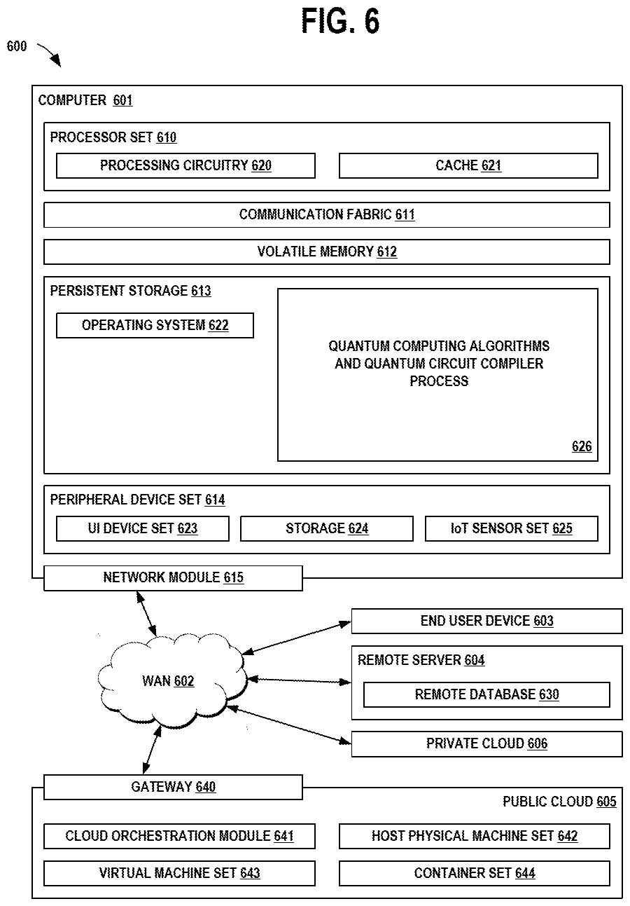

The quantum computing platform 510 comprises a software and hardware platform which comprises various software layers that are configured to perform various functions, including, but not limited to, generating and implementing various quantum applications using suitable quantum programming languages, configuring and implementing various quantum gate operations, compiling quantum programs into a quantum assembly language, implementing and utilizing a suitable quantum instruction set architecture (ISA), performing calibration operations to calibrate the quantum circuit elements and gate operations, etc. In addition, the quantum computing platform 510 comprises a hardware architecture of processors, memory, etc., which is configured to control the execution of quantum applications, and interface with the control system 520 to (i) generate digital control signals that are converted to analog microwave control signals by the control system 520, to control operations of the quantum processor 530 when executing a given quantum application, and (ii) to obtain and process digital signals received from the control system 520, which represent the processing results generated by the quantum processor 530 when executing various gate operations for a given quantum application. In some exemplary embodiments, the quantum computing platform 510 of the quantum computing system 500 may be implemented using any suitable computing system architecture (e.g., as shown in FIG. 6) which is configured to implement methods to support quantum computing operations by executing computer readable program instructions that are embodied on a computer program product which includes a computer readable storage medium (or media) having such computer readable program instructions thereon for causing a processor to perform control methods as discussed herein.

In some embodiments, the quantum computing platform 510 comprises a quantum computing service and programming model that implements the Open-Source Quantum Development Qiskit platform. As is known in the art, Qiskit is an open-source software development kit (SDK) for programming and working with quantum computers at the level of pulses, circuits, and application modules. In this instance, the quantum circuit compiler 514 is configured to translate Qiskit code into an optimized circuit using a native gate set of a given backend for a given quantum process, wherein the backend comprises either a simulator or real quantum computer. The Qiskit platform library can implement the ternary readout instruction for use with a standard commercial quantum computer that supports only binary state readout, and which supports mid-circuit measurement using dispersive readout techniques. This allows a user to implement and develop quantum algorithms which incorporate qutrits, such as quantum random access coding in a qutrit space, with standard commercial quantum computers that only support qubit readout.

The exemplary ternary readout techniques as discussed herein can be combined with the existing experiment library in Qiskit, currently referred to as Qiskit Experiments. For example, combining this technique promotes the standard randomized benchmarking (RB) experiment to a leakage RB to support an experimental method for measuring the average error rates of leakage from the computational basis to the second excited state of quantum computing hardware platforms. In some embodiments, the ternary (qutrit) measurement instruction can be implemented to allow an internal experimentalist to natively write experiments to characterize leakage error and allow a monitoring agent running on the quantum operating system to continuously monitor the leakage for self-diagnosis to realize robust quantum computing system. It is feasible to support parallel execution of such a monitoring task on huge number of qubits thanks to the capability of hardware-integration of the binary-outcome mid-circuit measurement.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 600 of FIG. 6 contains an example of an environment for the execution of at least some of the computer code involved in performing the inventive methods, such as program code for performing quantum computing algorithms and for implementing quantum circuit compiler process which is configured to, e.g., decode a ternary measurement instruction into a sequence of binary-outcome mid-circuit measurements to enable ternary state readout in a quantum processing system having a standard micro-architecture that is configured for the computational basis states of |0 [symbol] and |1 [symbol] as discussed above. In addition to block 626, computing environment 600 includes, for example, computer 601, wide area network (WAN) 602, end user device (EUD) 603, remote server 604, public cloud 605, and private cloud 606. In this embodiment, computer 601 includes processor set 610 (including processing circuitry 620 and cache 621), communication fabric 611, volatile memory 612, persistent storage 613 (including operating system 622 and block 626, as identified above), peripheral device set 614 (including user interface (UI), device set 623, storage 624, and Internet of Things (IoT) sensor set 625), and network module 615. Remote server 604 includes remote database 630. Public cloud 605 includes gateway 640, cloud orchestration module 641, host physical machine set 642, virtual machine set 643, and container set 644.

Computer 601 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 630. As is well understood in the art of computer technology, and depending upon the technology, performance of a computer-implemented method may be distributed among multiple computers and/or between multiple locations. On the other hand, in this presentation of computing environment 600, detailed discussion is focused on a single computer, specifically computer 601, to keep the presentation as simple as possible. Computer 601 may be located in a cloud, even though it is not shown in a cloud in FIG. 6. On the other hand, computer 601 is not required to be in a cloud except to any extent as may be affirmatively indicated.

Processor set 610 includes one, or more, computer processors of any type now known or to be developed in the future. Processing circuitry 620 may be distributed over multiple packages, for example, multiple, coordinated integrated circuit chips. Processing circuitry 620 may implement multiple processor threads and/or multiple processor cores. Cache 621 is memory that is located in the processor chip package(s) and is typically used for data or code that should be available for rapid access by the threads or cores running on processor set 610. Cache memories are typically organized into multiple levels depending upon relative proximity to the processing circuitry. Alternatively, some, or all, of the cache for the processor set may be located “off chip.” In some computing environments, processor set 610 may be designed for working with qubits and performing quantum computing.

Computer readable program instructions are typically loaded onto computer 601 to cause a series of operational steps to be performed by processor set 610 of computer 601 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 621 and the other storage media discussed below. The program instructions, and associated data, are accessed by processor set 610 to control and direct performance of the inventive methods. In computing environment 600, at least some of the instructions for performing the inventive methods may be stored in block 626 in persistent storage 613.

Communication fabric 611 is the signal conduction path that allow the various components of computer 601 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 612 is any type of volatile memory now known or to be developed in the future. Examples include dynamic type random access memory (RAM) or static type RAM. Typically, the volatile memory is characterized by random access, but this is not required unless affirmatively indicated. In computer 601, the volatile memory 612 is located in a single package and is internal to computer 601, but, alternatively or additionally, the volatile memory may be distributed over multiple packages and/or located externally with respect to computer 601.

Persistent storage 613 is any form of non-volatile storage for computers that is now known or to be developed in the future. The non-volatility of this storage means that the stored data is maintained regardless of whether power is being supplied to computer 601 and/or directly to persistent storage 613. Persistent storage 613 may be a read only memory (ROM), but typically at least a portion of the persistent storage allows writing of data, deletion of data and re-writing of data. Some familiar forms of persistent storage include magnetic disks and solid-state storage devices. Operating system 622 may take several forms, such as various known proprietary operating systems or open-source Portable Operating System Interface type operating systems that employ a kernel. The code included in block 626 typically includes at least some of the computer code involved in performing the inventive methods.

Peripheral device set 614 includes the set of peripheral devices of computer 601. Data communication connections between the peripheral devices and the other components of computer 601 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 623 may include components such as a display screen, speaker, microphone, wearable devices (such as goggles and smart watches), keyboard, mouse, printer, touchpad, game controllers, and haptic devices. Storage 624 is external storage, such as an external hard drive, or insertable storage, such as an SD card. Storage 624 may be persistent and/or volatile. In some embodiments, storage 624 may take the form of a quantum computing storage device for storing data in the form of qubits. In embodiments where computer 601 is required to have a large amount of storage (for example, where computer 601 locally stores and manages a large database) then this storage may be provided by peripheral storage devices designed for storing very large amounts of data, such as a storage area network (SAN) that is shared by multiple, geographically distributed computers. IoT sensor set 625 is made up of sensors that can be used in Internet of Things applications. For example, one sensor may be a thermometer and another sensor may be a motion detector.

Network module 615 is the collection of computer software, hardware, and firmware that allows computer 601 to communicate with other computers through WAN 602. Network module 615 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 615 are performed on the same physical hardware device. In other embodiments (for example, embodiments that utilize software-defined networking (SDN)), the control functions and the forwarding functions of network module 615 are performed on physically separate devices, such that the control functions manage several different network hardware devices. Computer readable program instructions for performing the inventive methods can typically be downloaded to computer 601 from an external computer or external storage device through a network adapter card or network interface included in network module 615.

WAN 602 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 603 is any computer system that is used and controlled by an end user (for example, a customer of an enterprise that operates computer 601), and may take any of the forms discussed above in connection with computer 601. EUD 603 typically receives helpful and useful data from the operations of computer 601. For example, in a hypothetical case where computer 601 is designed to provide a recommendation to an end user, this recommendation would typically be communicated from network module 615 of computer 601 through WAN 602 to EUD 603. In this way, EUD 603 can display, or otherwise present, the recommendation to an end user. In some embodiments, EUD 603 may be a client device, such as thin client, heavy client, mainframe computer, desktop computer and so on.

Remote server 604 is any computer system that serves at least some data and/or functionality to computer 601. Remote server 604 may be controlled and used by the same entity that operates computer 601. Remote server 604 represents the machine(s) that collect and store helpful and useful data for use by other computers, such as computer 601. For example, in a hypothetical case where computer 601 is designed and programmed to provide a recommendation based on historical data, then this historical data may be provided to computer 601 from remote database 630 of remote server 604.

Public cloud 605 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 605 is performed by the computer hardware and/or software of cloud orchestration module 641. The computing resources provided by public cloud 605 are typically implemented by virtual computing environments that run on various computers making up the computers of host physical machine set 642, which is the universe of physical computers in and/or available to public cloud 605. The virtual computing environments (VCEs) typically take the form of virtual machines from virtual machine set 643 and/or containers from container set 644. It is understood that these VCEs may be stored as images and may be transferred among and between the various physical machine hosts, either as images or after instantiation of the VCE. Cloud orchestration module 641 manages the transfer and storage of images, deploys new instantiations of VCEs and manages active instantiations of VCE deployments. Gateway 640 is the collection of computer software, hardware, and firmware that allows public cloud 605 to communicate through WAN 602.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 606 is similar to public cloud 605, except that the computing resources are only available for use by a single enterprise. While private cloud 606 is depicted as being in communication with WAN 602, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 605 and private cloud 606 are both part of a larger hybrid cloud.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A device, comprising:
memory that is configured to store program instructions; and
processing circuitry, coupled to the memory, and configured to execute the program instructions to perform a process to measure a quantum state of a quantum bit, wherein in performing the process, the processing circuitry is configured to:
cause a sequence of operations to be performed on the quantum bit, the sequence of operations comprising at least a first binary-outcome measurement operation, a quantum state-inverting gate operation, and a second binary-outcome measurement operation; and
determine a ternary measurement outcome, as the quantum state, based at least in part on discriminated binary-outcome measurements that result from the first binary-outcome measurement operation and the second binary-outcome measurement operation.

2. The device of claim 1, wherein:
the quantum state-inverting gate operation comprises a quantum X gate operation that is configured to flip a state the quantum bit in a computational state spanned by a ground state |0 [symbol] and a first excited state |1 [symbol] ; and
the first binary-outcome measurement operation and the second binary-outcome measurement operation are each performed using a mid-circuit measurement operation.

3. The device of claim 1, wherein in performing the process, the processing circuitry is configured to:
receive a ternary measurement instruction; and
translate the ternary measurement instruction into the sequence of operations to be performed on the quantum bit.

4. The device of claim 1, wherein the processing circuitry is configured to:
cause the sequence of operations to be repeated for a specified number of times;
for each sequence of operations that is performed, determine an associated single-shot ternary measurement outcome based on discriminated binary-outcome measurements that result from the sequence of operations; and
determine the ternary measurement outcome based on a plurality of single-shot ternary measurement outcomes obtained as a result of the repeated sequence of operations.

5. The device of claim 4, wherein for each sequence of operations that is performed, the processing circuitry is configured to determine the associated single-shot ternary measurement outcome by performing a statistical analysis of the discriminated binary-outcome measurements to estimate the single-shot ternary measurement outcome.

6. The device of claim 4, wherein for each sequence of operations that is performed, the processing circuitry is configured to determine the associated single-shot ternary measurement outcome by utilizing a hardware-based sequential logic circuit to process the discriminated binary-outcome measurements.

7. The device of claim 1, wherein:
the processing circuitry is configured to determine the ternary measurement outcome of the quantum state of the quantum bit as one of a ground state |0 [symbol] , a first excited state |1 [symbol] , and a second excited state |2 [symbol] ; and
the discriminated binary-outcome measurements each comprise a positive operator-valued measure (POVM) of {|0 [symbol] 0|, 1−0 [symbol] 0|}, wherein a ternary measurement outcome of the quantum state of the quantum bit as being the ground state |0 [symbol] is discriminated as a |0 [symbol] state, while a single-shot ternary measurement outcome of the quantum state of the quantum bit as being the first excited state |1 [symbol] or the second excited state |2 [symbol] is discriminated as a |1 [symbol] state.

8. The device of claim 1, wherein the sequence of operations comprises a sequence of multiple instances of a binary-outcome measurement followed by a quantum state-inverting gate operation, and a final binary-outcome measurement following the multiple instances of the binary-outcome measurement and the quantum state-inverting gate operation.

9. A system, comprising:
a quantum processing unit comprising a quantum processor comprising an array of quantum bits, and a control system configured to control operation of the quantum processor; and
a computing system configured to utilize the quantum processing unit to perform quantum computing algorithms, wherein the computing system comprises memory that is configured to store program instructions, and processing circuitry, coupled to the memory, and configured to execute the program instructions to perform a process to measure a quantum state of a quantum bit of the quantum processor, wherein in performing the process, the processing circuitry is configured to:
generate control signals that are applied to the control system of the quantum processing unit to cause the control system to perform a sequence of operations on the quantum bit, the sequence of operations comprising at least a first binary-outcome measurement operation, a quantum state-inverting gate operation, and a second binary-outcome measurement operation; and
determine a ternary measurement outcome, as the quantum state, based at least in part on discriminated binary-outcome measurements that result from the first binary-outcome measurement operation and the second binary-outcome measurement operation.

10. The system of claim 9, wherein in performing the process, the processing circuitry is configured to:
receive a ternary measurement instruction; and
translate the ternary measurement instruction into the sequence of operations to perform on the quantum bit.

11. The system of claim 9, wherein:
the quantum state-inverting gate operation comprises a quantum X gate operation that is configured to flip a quantum state of the quantum bit in a computational state spanned by a ground state |0 [symbol] and a first excited state |1 [symbol] ; and
the first binary-outcome measurement operation and the second binary-outcome measurement operation are each performed using a mid-circuit measurement operation.

12. The system of claim 11, wherein the control system of the quantum processing unit comprises:
a dispersive readout control system that is configured to perform a quantum non-demolition measurement to generate a readout signal which represents a quantum state of the quantum bit, in response to each of the first binary-outcome measurement operation and the second binary-outcome measurement operation, which are performed using the mid-circuit measurement operation; and
a hardware discriminator configured to generate the discriminated binary-outcome measurements.

13. The system of claim 9, wherein the processing circuitry is configured to:
cause the control system to repeat the sequence of operations for a specified number of times;
for each sequence of operations that is performed, determine an associated single-shot ternary measurement outcome based on discriminated binary-outcome measurements that result from the sequence of operations; and
determine the ternary measurement outcome based on a plurality of single-shot ternary measurement outcomes obtained as a result of the repeated sequence of operations.

14. The system of claim 13, wherein for each sequence of operations that is performed, the processing circuitry is configured to determine the associated single-shot ternary measurement outcome by performing a statistical analysis of the discriminated binary-outcome measurements received from the quantum processing unit to estimate the single-shot ternary measurement outcome.

15. The device of claim 13, wherein for each sequence of operations that is performed, the processing circuitry is configured to determine the associated single-shot ternary measurement outcome by utilizing a hardware-based sequential logic circuit to process the discriminated binary-outcome measurements received from the quantum processing unit.

16. The system of claim 9, wherein:
the processing circuitry is configured to determine the ternary measurement outcome of the quantum state of the quantum bit as one of a ground state |0 [symbol] , a first excited state |1 [symbol] , and a second excited state |2 [symbol] ; and
the discriminated binary-outcome measurements each comprise a positive operator-valued measure (POVM) of {|0 [symbol] 0|, 1−|0 [symbol] 0|}, wherein a ternary measurement outcome of the quantum state of the quantum bit as being the ground state |0 [symbol] is discriminated as a |0 [symbol] state, while a single-shot ternary measurement outcome of the quantum state of the quantum bit as being the first excited state 1 [symbol] or the second excited state |2 [symbol] is discriminated as a |1 [symbol] state.

17. A computer program product for performing a process to measure a quantum state of a quantum bit, the computer program product comprising:
one or more computer readable storage media, and program instructions collectively stored on the one or more computer readable storage media, the program instructions comprising:
program instructions to cause a sequence of operations to be performed on the quantum bit, the sequence of operations comprising at least a first binary-outcome measurement operation, a quantum state-inverting gate operation, and a second binary-outcome measurement operation; and
program instructions to determine a ternary measurement outcome, as the quantum state, based at least in part on discriminated binary-outcome measurements that result from the first binary-outcome measurement operation and the second binary-outcome measurement operation.

18. The computer program product of claim 17, wherein:
the quantum state-inverting gate operation comprises a quantum X gate operation that is configured to flip a state the quantum bit in a computational state spanned by a ground state |0 [symbol] and a first excited state |1 [symbol] ; and
the first binary-outcome measurement operation and the second binary-outcome measurement operation are each performed using a mid-circuit measurement operation.

19. The computer program product of claim 17, wherein the program instructions to cause the sequence of operations to be performed on the quantum bit comprise program instructions to cause the sequence of operations to be repeated for a specified number of times, and further comprising:
program instructions to determine, for each sequence of operations that is performed, an associated single-shot ternary measurement outcome based on discriminated binary-outcome measurements that result from the sequence of operations; and
program instructions to determine the ternary measurement outcome based on a plurality of single-shot ternary measurement outcomes obtained as a result of the repeated sequence of operations.

20. The computer program product of claim 19, further comprising program instructions to determine, for each sequence of operations that is performed, the associated single-shot ternary measurement outcome by one of: performing a statistical analysis of the discriminated binary-outcome measurements to estimate the single-shot ternary measurement outcome; and utilizing a hardware-based sequential logic circuit to process the discriminated binary-outcome measurements.
